(19) United States
(12) Patent Application Publication
(10) Pub. No.: US 2024/0210366 A1
(43) Pub. Date: Jun. 27, 2024

(54) DATA PROCESSING METHOD AND DEVICE FOR CHROMATOGRAM, CHROMATOGRAPHIC DEVICE, AND RECORDING MEDIUM

(71) Applicant: HITACHI HIGH-TECH SCIENCE CORPORATION, Tokyo (JP)

(72) Inventors: Masato FUKUDA, Tokyo (JP); Minling PEI, Tokyo (JP); Masahito ITO, Tokyo (JP)

(21) Appl. No.: 18/540,375

(22) Filed: Dec. 14, 2023

(30) Foreign Application Priority Data
Dec. 22, 2022 (JP) 2022-205264

(51) Int. Cl. G01N 30/86; B01D 15/20

(52) U.S. Cl. CPC G01N 30/8631; B01D 15/203

(57) ABSTRACT

Disclosed is a method for identifying the accurate number of peaks which includes a peak extraction process of extracting a number of target peaks corresponding to a number of target components to be identified, among the multiple components from a group of peaks appearing on the chromatogram, a peak identification process that assigns names of the target components to the target peaks in descending or ascending order of first retention time, based on a standard sample timetable preloaded with a relationship between the names of the target components and the corresponding first retention times, which are retention times of the target components, is stored, and a standard sample timetable updating process that updates the first retention times in the standard sample timetable, with second retention times that are measured retention times of the target peaks.

### CROSS REFERENCE TO RELATED APPLICATION(S)

This application claims the benefit of Japanese Patent Application No. 2022-205264, filed Dec. 22, 2022, which is hereby incorporated by reference in its entirety into this application.

### BACKGROUND OF THE INVENTION

### Technical Field

The present disclosure relates to a data processing method and device for processing chromatograms, a chromatographic device including the data processing device, a chromatogram data processing program, and a recording medium.

### Background Art

Chromatographic analysis using a chromatographic device, such as liquid chromatography or gas chromatography, is generally performed according to the procedures described below. That is, first, a chromatogram of a known standard sample containing a specific component is measured, and the retention time and allowable width of the peak of the specific component are recorded in a table. Next, a chromatogram of an unknown measurement sample is measured. When this chromatogram has a measurement peak having the same retention time within an allowable range as the retention time recorded in the table occurs, the measurement peak is determined as the peak of the specific component.

Patent Document 1 discloses a data processing device that automates such chromatographic analysis processing and generates a time window for each component peak of a standard sample. Patent Document 1 discloses “To provide a data processor of a chromatograph for identifying a standard sample and a measurement sample by considering deviation of holding time of a peak because of a variation in a measurement condition, the followings are equipped: a standard sample timetable; a peak number determination part for determining whether the number of measured peaks agrees with the number of prescribed peaks when at least one measured peak is not identified in identification of a chromatogram of a standard sample; a standard sample timetable change part for changing a standard sample timetable in affirmative determination; a standard sample identification part for identifying measured peaks when all of the measured peaks having strength of a predetermined threshold value or higher remain within a range of a change permission width W2 in the changed standard sample timetable; and a measurement sample timetable setting part for acquiring actual holding time of measured peaks and measuring the measurement sample timetable in identification of the measured peaks” (refer to ABSTRACT).

### DOCUMENT OF RELATED ART

### Patent Document

[Patent Document 1] Japanese Patent Application Publication No. 2019-56620

### SUMMARY OF THE INVENTION

### Technical Problem

The technology described in Patent Document 1 has problems that the lower threshold value of a detection signal for counting peaks is fixed, and the technology has low flexibility against changes in the chromatogram due to changes in the state of a standard sample or a measurement sample, measurement conditions, etc.

An object of the present disclosure is to provide a peak identification technique for accurately identifying the number of peaks in response to changes in a chromatogram, which are attributed to changes in the state of a standard sample or measurement sample, changes in measurement conditions, etc.

### Technical Solution

To accomplish the above-mentioned object, for example, the configurations recited in the claims are employed.

The present disclosure includes multiple means for accomplishing the object, but one example is a data processing method for a chromatogram of a standard sample containing multiple components, the method comprising:
a peak extraction process of extracting a number of target peaks corresponding to the number of identification target components among the multiple components from a group of peaks appearing on a chromatogram;
a peak identification process of assigning names of the respective target components to the respective target peaks in descending or ascending order of first retention time, by referring to a standard sample timetable in which a relationship between each of the names of the respective target components and a corresponding one of the first retention times which are the retention times of the respective target components, is stored; and
a standard sample timetable updating process of replacing the first retention time of the standard sample timetable with a second retention time that is a measured retention time of the target peak.

### Advantageous Effects

According to the present disclosure, it is possible to provide a technique for identifying the accurate number of peaks according to changes in a chromatogram, which are attributed to fluctuations in the states of standard samples and measurement samples, measurement conditions, and the like.

### DESCRIPTION OF DRAWINGS

FIG. 1 is a view illustrating the construction of a chromatographic device including a chromatogram data processing device according to one embodiment of the present disclosure.

FIG. 2 illustrates an example of a VIS1 standard sample timetable.

FIG. 3 illustrates an example of a VIS1 chromatogram of a standard sample.

FIG. 4 is an example of a processing flow performed by a data processing device.

FIG. 5 is an example of a processing flow in part A (VIS2) of FIG. 4.

FIG. 6 is an example of a VIS1 standard sample timetable modified using a changed tolerance width W2.

FIG. 7 is a view illustrating an aspect of identifying a measured peak of a standard sample in a modified VIS1 standard sample timetable.

FIG. 8 is a view illustrating an example of a standard sample timetable updated with measured retention times and second tolerances W3ᵢ.

FIG. 9 is a view illustrating an example of a VIS2 standard sample timetable.

FIG. 10 is view illustrating an example of a VIS2 standard sample timetable modified using changed tolerance widths W2ⱼ.

FIG. 11 is a view illustrating an example of a VIS2 standard sample timetable updated with measured retention times Q3 and second tolerance widths Z3ᵢ.

FIG. 12 is a view illustrating an example of an input screen for setting changed tolerance widths W2.

FIG. 13 is a view illustrating another example of an input screen for setting changed tolerance widths W2.

FIG. 14 is a view illustrating a processing method of marking identified peaks disposed outside the first tolerance width W1.

FIG. 15 is a view illustrating an example of an aspect of displaying marks attached to the identified peaks disposed outside the first tolerance width W1.

FIG. 16 is a view illustrating an example of an aspect of displaying marks attached to the identified peaks disposed outside the first tolerance width W1.

FIG. 17 is a view illustrating three groups of amino acids.

FIG. 18 is a view illustrating determination of a correlation coefficient.

FIG. 19A is a view illustrating an example of an operation screen displayed on a display unit of the data processing device.

FIG. 19B is a view illustrating an example of an operation screen displayed on the display unit of the data processing device.

FIG. 19C is a view illustrating an example of an operation screen displayed on the display unit of the data processing device.

FIG. 20 is a view illustrating a processing flow showing an example of a peak position correction function.

FIG. 21A is a view illustrating an example of an operation screen displayed on the display unit of the data processing device.

FIG. 21B is a view illustrating an example of an operation screen displayed on the display unit of the data processing device.

FIG. 22 is a view illustrating an example of an operation screen displayed on the display unit of the data processing device.

FIG. 23 is a view illustrating a processing flow of a threshold value adjustment-type peak extraction function.

FIG. 24 is a process flow of a maximum value search method.

FIG. 25 illustrates examples of chromatograms for VIS1 and VIS2.

### BEST MODE

Embodiments of the present disclosure will be described below with reference to the drawings. The following description of the embodiments is merely illustrative in nature and is not intended to limit the present disclosure, applications of the present disclosure, or uses of the present disclosure.

### Embodiment 1

### Glossary

Herein, a device that performs chromatographic analysis is referred to as a “chromatograph” or “chromatographic device”. In addition, analytical data obtained as a result of chromatographic analysis is referred to as a “chromatogram”.

As used herein, the term “measurement sample” refers to a sample to be measured, such as a sample containing an unknown component at an unknown concentration. In addition, the term “standard sample” is a sample that serves as an external standard material used for identification and quantification of components contained in a measurement sample, and is a sample that contains multiple known components at known concentrations.

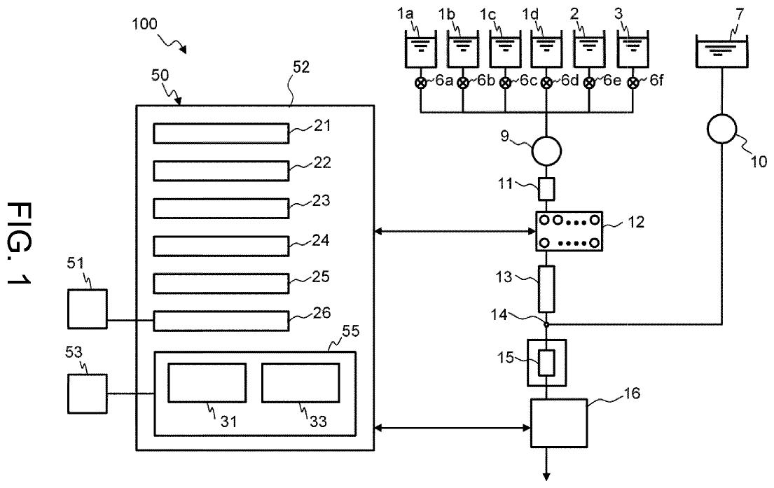

### <Hardware Configuration>

[Chromatographic device] FIG. 1 is a view illustrating the construction of a chromatographic device 100 including a chromatogram data processing device 50 relating to one embodiment of the present disclosure. In this example, the chromatographic device 100 is a liquid chromatograph for amino acid analysis. In the chromatographic device 100, a separation column is used to separate an analyte component in an amino acid sample, which is a standard sample or a measurement sample. Then, a derivatization process of selectively chemically modifying the amino acids, which are the separated analyte components, to change the amino acids into visible or fluorescent substances is performed, and the substances are detected by a detector. Note that the standard sample contains several known amino acids in respectively predetermined amounts.

Specifically, the chromatographic device 100 includes first to fourth eluent tanks 1a to 1d for analysis, a distillation tank 2 for washing a separation column, and a column regeneration liquid tank 3 for regenerating the separation column. Solenoid valves 6a to 6f are arranged downstream of the respective tanks. Channels connected to the respective tanks merge into one channel disposed downstream sides of the respective solenoid valves 6a to 6f, and the integrate channel is connected to an eluent pump (plunger pump) 9.

At the time of analysis, a desired eluent is selected by operating a targeted one of the solenoid valves 6a to 6d respectively corresponding to the first to fourth eluent tanks 1a to 1d. The eluent is pumped and transported to an ammonia filter column 11 by the eluent pump 9. The eluent is then sent to the separation column 13 along with the amino acid sample introduced into the eluent, by an autosampler 12. Then, the amino acid sample in the eluent is separated in the separation column 13.

The chromatographic device 100 further includes a ninhydrin reagent tank 7. A channel connected to the ninhydrin reagent tank 7 is connected to a mixer 14 arranged downstream of the separation column 13. A ninhydrin pump 10 is arranged on the channel.

In the mixer 14, the eluate containing each amino acid component separated by the separation column 13 is mixed with the ninhydrin reagent sent by the ninhydrin pump 10, and then sent to a reactor 15 disposed downstream of the mixer 14. The eluate is heated in the reactor 15, and a ninhydrin reaction between each amino acid component and the ninhydrin reagent proceeds. The amino acid colored (Ruhemann's purple) by the ninhydrin reaction is continuously detected by a detector 16 disposed downstream of the reactor 15. The detection results output from the detector 16 are recorded and stored as data such as chromatograms by the data processing device 50.

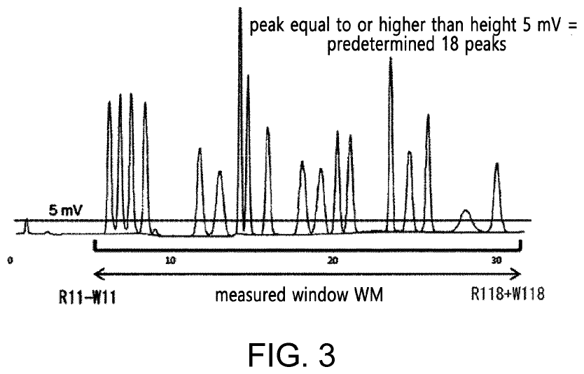

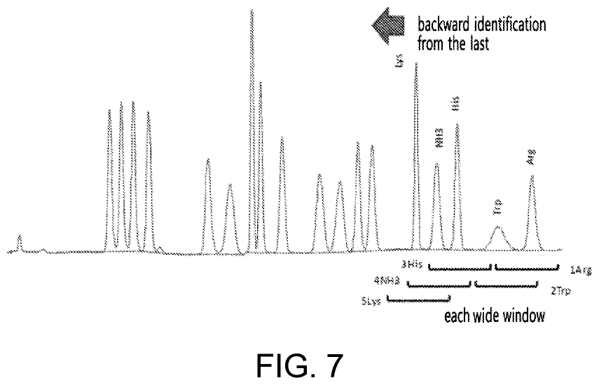

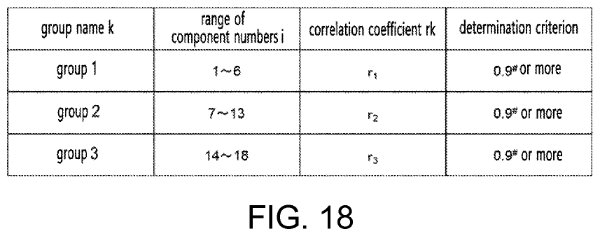

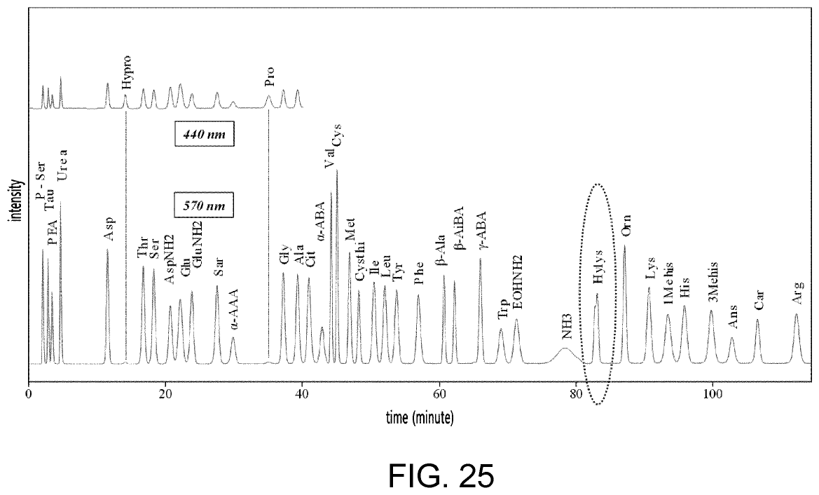

In this example, the chromatographic device 100 includes a visible absorption spectrophotometer as the detector 16. The visible absorption spectrophotometer can detect component using two detection wavelengths: 570 nm on a first channel (also called “main channel”, “VIS1”) and 440 nm on a second channel (also called “subchannel”, “VIS2”). Herein, the chromatogram obtained from VIS1 measurement is referred to as a VIS1 chromatogram (first chromatogram, main chromatogram), and the chromatogram obtained from VIS2 measurement is referred to as a VIS2 chromatogram (second chromatogram, subchromatogram). Examples of the VIS1 chromatograms are the chromatograms shown in FIGS. 3 and 7, and the chromatograms displayed at the bottom among the chromatograms in FIGS. 15 and 25. Examples of the VIS2 chromatograms are the chromatograms displayed at the top among the chromatograms in FIGS. 15 and 25.

### [Data Processing Device]

The data processing unit 50 is composed of a personal computer, for example, and is equipped with an operation unit 52 such as a central control unit (CPU), a memory unit 55 such as RAM, ROM, a hard disk, and a network server, a display unit 51 such as a monitor, and an input unit 53 such as a keyboard to which user instructions are input.

In the data processing device 50, a peak extraction unit 21, a standard sample timetable modification unit 22 (peak identification unit), a standard sample identification unit 23 (peak identification unit), a measurement sample timetable setting unit 24 (standard sample timetable updating unit), a measurement sample identification unit 25, and an output instruction unit 26 are implemented as computer programs or the like.

That is, at least a portion of each procedure of the processing flow described below is programmed and implemented in the data processing device 50. In other words, the chromatogram data processing program of the present disclosure is a computer program for chromatogram data processing that causes a computer to perform at least a peak extraction process, a peak identification process, and a standard sample timetable updating process in the processing flow described below.

These computer programs and the like are read out from, for example, a ROM or the like and executed by the operation unit 52. Furthermore, these computer programs and the like are not limited to being stored in the memory unit 55, but can be stored in various known computer-readable recording media, such as optical disk media and magnetic tape media. The computer program, etc. can be executed by loading such a recording medium in a readout device (not shown) of the data processing unit 50 and reading out the computer program, etc.

When the user inputs the instruction to start measurement by using the input unit 53, the autosampler 12 takes in an amino acid sample according to an instruction issued by the data processing device 50. Then, the analysis of the amino acid sample described above is performed according to, for example, a separation program that is set up in advance by the user, and the obtained chromatogram and other data are stored in the memory unit 55.

### [Standard Sample Timetable and Measurement Sample Timetable]

The memory unit 55 contains a standard sample timetable 31 and a measurement sample timetable 33.

The standard sample timetable 31 is a timetable used for peak identification and quantification of standard samples. The standard sample timetable may include a standard sample timetable for VIS1 (standard sample timetable for the first channel, or standard sample timetable for the main channel) and a standard sample timetable for VIS2 (standard sample timetable for the second channel, or standard sample for the subchannel). The standard sample timetable for VIS1 shows the relationship between the name of a first target component, which is the identification target on VIS1, a first retention time that is the retention time of the first target component, and a first tolerance width as necessary. The standard sample timetable for VIS2 shows the relationship between the name of a second target component, which is the identification target on VIS2, a second retention time that is the retention time of the first target component, and a first tolerance width as necessary. The information of the first retention time information stored in the standard sample timetable may be updated to the information of the actual measured retention time (second retention time) in a step of the processing flow described below. The information of the first tolerance width stored in the standard sample timetable may be updated to the information of the change tolerance width or second tolerance width in a step of the processing flow described below.

The measurement sample timetable 33 is a timetable used for peak identification and quantification of the measurement sample, and is set based on the standard sample timetable as described later. The measurement sample timetable 33 includes a VIS1 measurement sample timetable (measurement sample timetable for the first channel, measurement sample timetable for the main channel) and, if necessary, a VIS2 measurement sample timetable (measurement sample timetable for the second channel, measurement sample timetable for the subchannel).

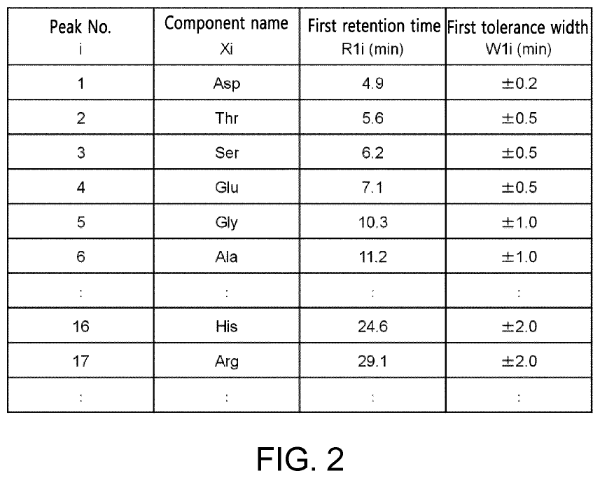

FIG. 2 is an example of the VLSI standard sample timetable 31. FIG. 3 is an example of a VIS1 chromatogram of a standard sample.

As shown in FIG. 2, the VIS1 standard sample timetable 31 for before analysis of the standard sample (in this specification, referred to as “original VIS1 standard sample timetable 31”) stores a first retention time R1i and a first tolerance width W1i for each of the peaks of respective components in the standard sample, detected at VIS1. Here, i is a natural number of 1 or more. Note that i=1 is the peak of the first component with the shortest retention time and corresponds to Asp (aspartic acid), for example. The first retention time of the peak at i=1 is denoted by R11, and the first tolerance width is denoted by W11. The same applies to the peaks after i=2 and onward. Further, in this example, i=1 to 18.

In addition, as shown in FIG. 3, there are multiple measured peaks in the chromatogram of the standard sample (in this example, there are 18 original peaks when are accurately measured at VIS1). Among these, measured peaks with intensities greater than (5 mV) are also shown. Note that the retention time of the measured peak is the measured retention time T (second retention time).

### <Processing Flow>

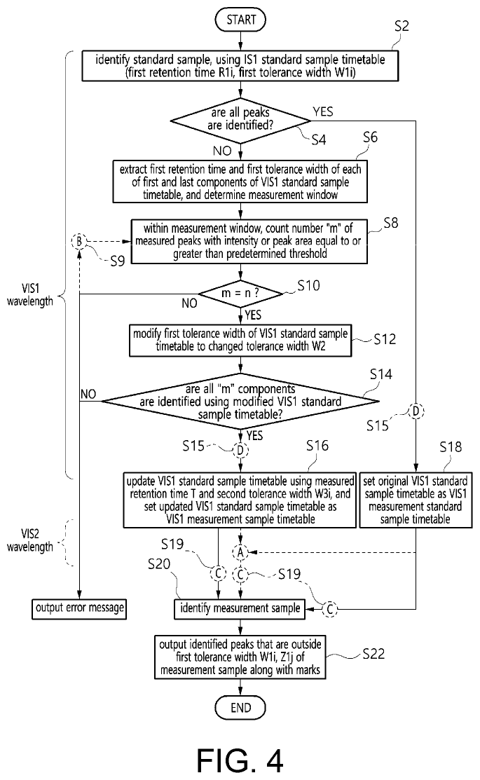

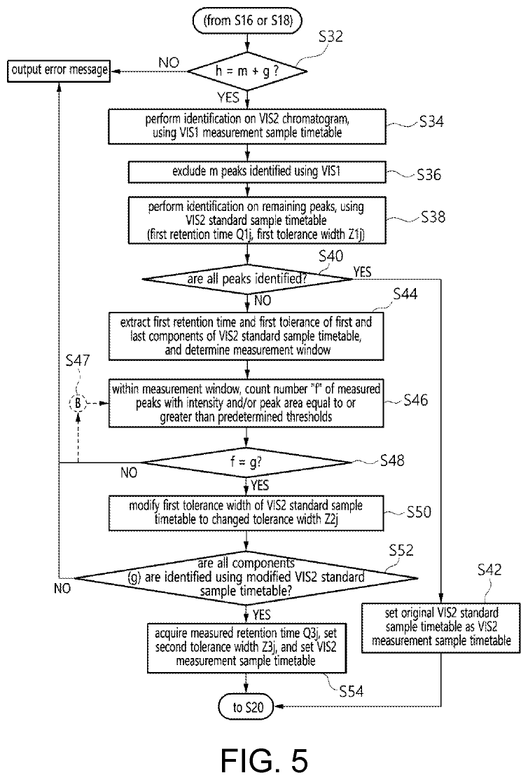

Next, with reference to FIGS. 4 and 5, the flow of the processing performed by the data processing device 50, which is a chromatogram data processing method according to the present disclosure, will be described.

First, the standard sample identification unit 23 extracts identification target components at VIS1 (number of components=n) from the VIS1 standard sample timetable 31 (first retention times R1ᵢ, and first tolerance widths W1ᵢ) shown in FIG. 2 and confirms the number of peaks identified from the peak identification results of the measured standard sample (step S2). The identification of the standard sample is performed according to the typical method. That is, it is determined whether the respective measured peaks in the chromatogram of the measured standard sample match the respective first retention times R1ᵢ within the respective tolerance width ranges of the respective first tolerance widths W1ᵢ (i is a natural number of 1 or more) in the standard sample timetable 31. The tolerance range is determined by the first retention time R1ᵢ and the corresponding first tolerance width W1j. That is, in this specification, the term “tolerance range” means a numerical range obtained by adding and subtracting the absolute value of the tolerance width to the retention time. When there are multiple measured peaks within one tolerance range, only one peak (for example, one peak with the longest retention time) is identified according to a predetermined rule. The identification of the remaining peaks is performed in the same manner. In this specification, each reference sign with the subscript “i” or the subscript “j” (such as R1ᵢ or R1ⱼ) may be used without the subscript “i” or “j” (for example, the case of “R1;”, the subscript “i” may be omitted and the reference sign is referred to as “R1”).

Then, the standard sample identification unit 23 determines whether the respective first retention times R1ᵢ (in this example, i=1 to 18) stored in the standard sample timetable 31 match the respective measured actual peaks (whether identified) (step S4). When the answer is determined to be “Yes” in step S4, the original standard sample timetable 31 can be used for measurement without any problem. That is, there is no need to consider the shift in peak retention time due to variations in measurement conditions. Therefore, the measurement sample timetable setting unit 24 sets the original VIS1 standard sample timetable 31 as the VIS1 measurement sample timetable and confirms the VIS1 measurement sample timetable 33 (step S18). The first tolerance width W1i of the original standard sample timetable 31 may be changed (for example, narrowed) to set the measurement sample timetable.

On the other hand, when the answer is determined to be “No” in step S4, the measurement cannot be made with the original VIS1 standard sample timetable 31. That is, there is need to consider the shift in peak retention time due to variations in measurement conditions. Therefore, the processing flow proceeds to the following process.

First, the peak extraction unit 21 extracts the first retention times R11 and R118 and the first tolerance widths W11 and W118 for the first component (i=1) and the last component (i=18) of the VIS1 standard sample timetable 31, and determines the measurement window WM (step S6). Specifically, for example, as shown in FIG. 3, the measurement window WM is the time interval from (the shortest first retention time R11−first tolerance width W11) to (the longest first retention time R118+first tolerance width W118).

The method of setting the measurement window WM is not particularly limited. For example, the time interval can be longer than the time interval from (first retention time R11−first tolerance width W11) to (first retention time R118+first tolerance width W118), or may be within a predetermined range. However, as mentioned above, when the time interval is from (first retention time R11−first tolerance width W11) to (first retention time R118+first tolerance width W118), the measurement window WM can be set to cover then the range of measured actual peaks without excess or deficiency, and the number of peaks can be more easily and accurately counted in the next step S8.

Next, in step S8 and step S10, which are peak extraction processes, the peak extraction unit 21 extracts a number of target peaks corresponding to the number “n” of target components (in this example, n=18), which are identification targets among multiple components, from a group of peaks appearing on the chromatogram of the standard sample. In this example, in the peak extraction process, among the group of peaks, the peak whose maximum value of the signal intensity exceeds the threshold value is extracted as the target peak.

Specifically, for example, as shown in FIGS. 3 and 4, within the measurement window WM, the number m of measured peaks having an intensity equal to or greater than a predetermined threshold value (5 mV in this example) is counted (step S8). In step S8, the number m of measured peaks may be counted using the peak area instead of or in addition to the intensity. Specifically, instead of the intensity, the number m of peaks having a peak area equal to or greater than a predetermined threshold value (for example, 1,000,000 μV·s) may be counted. In addition, after counting the number of measured peaks with an intensity equal to or greater than a predetermined threshold value, the number m of peaks having a peak area equal to or greater than a predetermined threshold value may be further counted. Whether to select intensity or peak area as a parameter for counting the number m of measured peaks, or to select both may be determined depending on the standard sample and the measurement sample.

Then, the peak extraction unit 21 determines whether or not the number m of measured peaks matches the specified number n of peaks (18 peaks in this example) specified for the standard sample be identified and quantified at the VIS1 (step S10).

When the answer is “Yes” in step S10, the processing flow proceeds to steps S12 and S14, which correspond to the peak identification process. The peak identification process is a process of assigning names of target components to target peaks in ascending or descending order of the first retention times, on the basis of the standard sample timetable.

Specifically, first, the standard sample timetable modification unit 22 changes the first tolerance width W1 of the original standard sample timetable to a tolerance width W2 that is wider than the first tolerance width W1 (step S12).

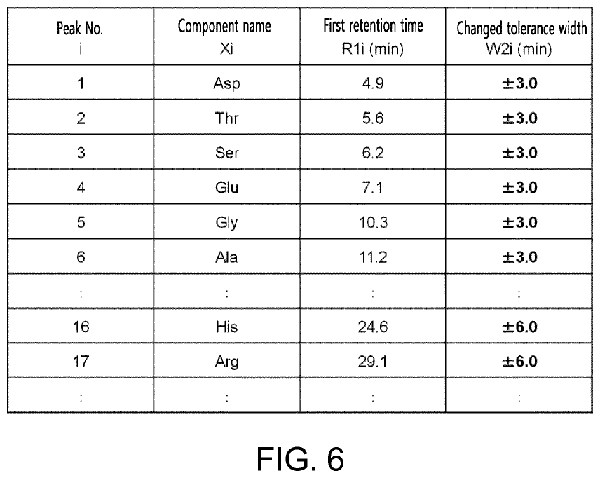

FIG. 6 is a diagram showing the data configuration of the standard sample timetable 31 for VIS1 in which the tolerance width is changed to the tolerance width W2. As shown in FIG. 6, the changed tolerance widths W2ᵢ in the modified VIS1 standard sample timetable 31 are larger than the first tolerance widths W1ᵢ shown in FIG. 2, respectively. The method of setting the changed tolerance widths W2ᵢ is not limited, but in this example, the changed tolerance width W2 is set to ±3.0 min for i=1 to 6, and the changed tolerance width W2 is set to ±6.0 min for i=7 or onward. A modification of the method for setting the changed tolerance width W2i will be described later.

As a method of modifying the standard sample timetable 31, in the case where the table is overwritten, the data of the original first tolerance width W1ᵢ will be lost. Therefore, the first tolerance widths W1ᵢ may be recorded in a separate region which cannot be overwritten so that the first tolerance widths W1ᵢ can remain. Alternatively, the original standard sample timetable 31 may be preserved as it is, and the modified standard sample timetable can be additionally recorded as a changed table.

On the other hand, when the answer is “No” in step S10, the standard sample timetable modification unit 22 neither modify the original standard sample timetable nor perform the subsequent processing steps, but ends the process while outputting an error. This is because when the measurement results in “No” in step S10, the measurement may become inaccurate in the case where the shift of the retention time of the peak exceeds a level that cannot be compensated for, due to some factors such as changes in the measurement conditions or deterioration of the standard sample.

Following step S12, the standard sample identification unit 23 determines whether all the measured peaks (18 peaks in this example) counted in step S8 have been identified from the modified VIS1 standard sample timetable 31 (step S14). The identification is a process of determining whether or not the m measured peaks match the respective first retention times R1ᵢ within respective tolerance ranges including the respective changed tolerance widths W2ᵢ in the modified standard sample timetable 31. The tolerance range is the retention time R1; and the changed tolerance width W2ᵢ corresponding thereto.

FIG. 7 shows a mode of identifying measured peaks of standard samples in the modified standard sample timetable 31. In this example, identification is performed in ascending order of peaks with longer retention times, with the use of the respective changed tolerance widths W2ᵢ. Identification may be performed with the changed tolerance widths W2ᵢ in descending order of peaks with shorter retention times.

When the answer is “Yes” in step S14, the processing flow proceeds to step S16, which includes a standard sample timetable updating process. The standard sample timetable updating process is a process of replacing the first retention times of the standard sample timetable with the respective second retention times, which are measured retention times of the measured peaks.

Specifically, the measurement sample timetable setting unit 24 acquires the actual retention times of the actual measured peaks as actual retention times T, and updates the VIS1 standard sample timetable with the actual retention times T and predetermined second tolerance widths W3. Then, the updated VIS1 standard sample timetable is set as the VIS1 measurement sample timetable 33 (step S16).

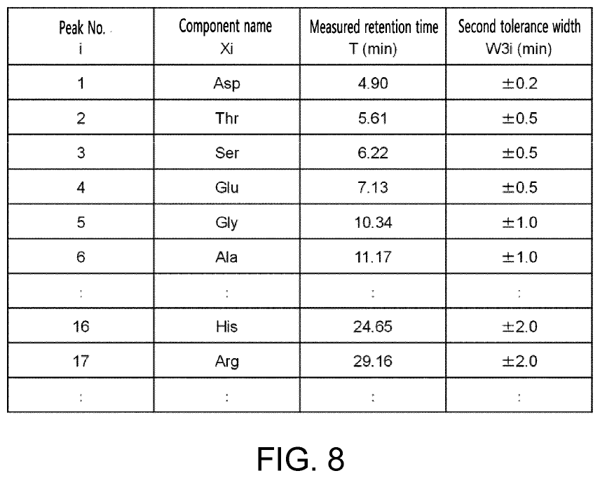

FIG. 8 is a diagram showing the data configuration of the updated VIS1 standard sample timetable (measured retention times T and second tolerance widths W3ᵢ). For example, at the peak of the second component (Thr: threonine, i=2), the actual retention time T2 is 5.61 min, while the first retention time R12 is 5.6 min. Therefore, the information of the retention time of the threonine Thr in the VIS1 measurement sample timetable 33 is updated to the actual measurement retention time T2=5.61 min.

In this example, the second tolerance width W3ᵢ is set to the original first tolerance width W1ᵢ, i.e., the second tolerance width W3ᵢ is narrower than the changed tolerance width W2. By changing the second tolerance width W3ᵢ to be narrower than the changed tolerance width W2ᵢ, errors in peak identification during analysis of a measurement sample can be suppressed, and analysis accuracy is improved. However, the method of setting the second tolerance width W3ᵢ is not limited to this method.

On the other hand, when the answer is “No” in step S14, the measurement sample timetable setting unit 24 neither perform the subsequent processing steps nor modify the original VIS1 standard sample timetable, but outputs an error and ends the processing. This is because like the case of step S10, when the measurement results in “No” in step S10, there is likelihood that the measurement is inaccurate in the case where the shift of the retention time of the peak exceeds a level that cannot be compensated for.

When all the target components can be identified by the measurement using VIS1, the measurement sample is analyzed. Specifically, the measurement sample identification unit 25 uses the VIS1 measurement sample timetable 33 obtained in step S16 or step S18 to identify the peak of the measurement sample, and to perform quantification by calculating the peak area (step S20). Then, if necessary, an optional step S22 described later is performed, and the analysis ends.

### [Special Case of Proline (Pro)]

There are some amino acid samples containing components that are difficult to identify and quantify by VIS1 measurement. For example, imino acid components such as proline (Pro) and hydroxyproline (Hypro) have relatively small peaks in the VIS1 which make identification and quantification chromatogram, difficult.

Therefore, while identifying an amino acid component (first target component) with the use of VIS1, imino acid components (second components) such as Pro and Hypro that are difficult to identify and quantify with VIS1 are identified and quantified with VIS2.

In addition, in the VIS2 chromatogram, other amino acid peaks to be identified with VIS1 also exist and have certain heights (see, for example, FIG. 25). Therefore, desirably, after identifying amino acid peaks using the VIS1 chromatogram, a process of identifying Pro and Hypro on the VIS2 chromatogram is performed. Desirably, the components identified from the VIS1 chromatogram, using the retentions of the respective amino acid components that have been already identified with VIS1, are not identified from the VIS2 chromatogram. In other words, after identifying target peaks of other amino acids in the VIS1 chromatogram, using the VIS1 standard sample timetable, desirably, peaks corresponding to the other amino acids are excluded from a group of peaks of the VIS2 chromatogram, and target peaks of imino acids may be identified using the VIS2 standard sample timetable. This facilitates the task of selecting components to be identified by VIS2 from among the peaks appearing in the VIS2 chromatogram and assigning component names.

Specifically, an example of a method of identifying and quantifying components using VIS2 as well as VIS1 is shown by the broken line in FIG. 4 and in FIG. 5. In addition, the flow indicated by the broken line in FIG. 4 is a flow in which a processing flow A regarding VIS2 is set between steps S16 and S18, and step S20.

FIG. 5 shows details of the processing flow A in FIG. 4. As shown in FIGS. 4 and 5, after step S16 or step S18, measurement is performed at a wavelength VIS2 different from VIS1 to create a measurement sample timetable for VIS2.

Since the peaks of Pro and Hypro are identified and quantified at VIS2, it is desirable that Pro and Hypro not be identified (not be detected) at VIS1. Therefore, when using VIS2, it is desirable that the threshold value in step S8 in FIG. 4 be set to a value at which Pro and Hypro are not detected. That is, it is desirable that a predetermined threshold value be set so that “Yes” is determined in step S10 and that Pro and Hypro are not detected in step S8. However, Pro and Hypro can be detected depending on the settings of the predetermined threshold. In such a case, it is desirable to increase the predetermined threshold value in step S8 so that Pro or Hypro cannot be detected.

Specifically, for example, in FIG. 3, a threshold value of intensity or peak area, which is regarded as a peak in the entire measurement wavelength range of VIS1 is set. In FIG. 3, an intensity of 5 mV is set as the threshold. When the number m of peaks detected in this case exceeds n, the threshold value is sequentially increased until the number m of detected peaks matches n. Then, in the VIS1 wavelength range, peak identification is performed in a state where Pro and the like are not detected. Specifically, for example, the threshold value in step S8 is doubled (for example, the intensity is 10 mV in FIG. 3).

Following step S16 or S18 in FIG. 4, in step S32 in FIG. 5, it is determined whether the value obtained by adding g to the number m of peaks identified in step S10 in FIG. 4 matches the number h of detection target components to be detected at VIS2. Here, g is the number of peaks that are not identified and quantified at the wavelength VIS1 but are identified and quantified at the wavelength VIS2. For example, in the case of a general amino acid standard sample as shown in FIG. 3, since Pro is included as a component to be identified with the use of the wavelength VIS2, g=1. In addition, in a biological fluid analysis method in which the number of components is about 40, since the amino acid sample contains Pro and Hypro that are components to be identified with the use of the wavelength VIS2, g=2. That is, in the example of FIG. 3, since the amino acid sample contains Pro, g=1, n=m=18, and h=19.

When the answer is “No” in step S32, an error is output, and the process ends. This is because when the measurement results in “No” in step S32, there is a possibility that the measurement is inaccurate because the shift of the retention time of the peak exceeds a level that cannot be compensated for.

When the answer is “Yes” in step S32, the peaks of the components that have been identified and quantified with the use of the wavelength VIS1 by using the VIS1 measurement sample timetable 33 confirmed in step S16 or S18 are extracted, and the components are excluded from the identification targets in the subsequent steps (steps S34, S36).

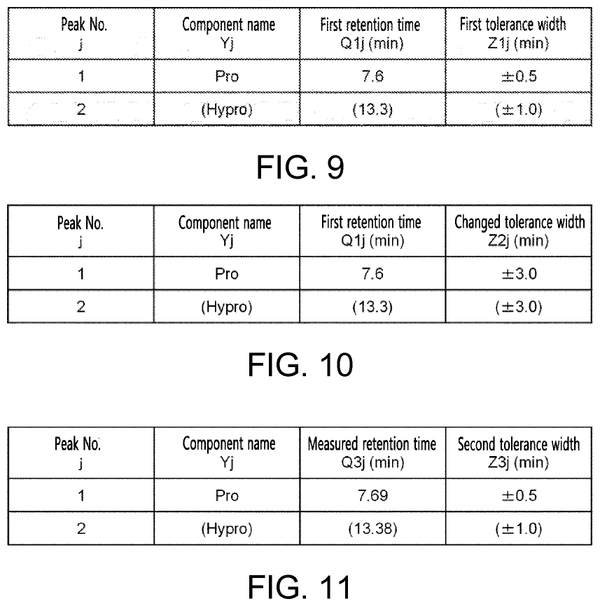

Regarding the remaining measured peaks after exclusion, the standard sample identification unit 23 identifies the standard sample using the VIS2 standard sample timetable 31 (first retention time Q1ⱼ, first tolerance width Z1ⱼ) in FIG. 9 (step S38). The identification of the standard sample is performed according to the typical method. That is, it is determined whether the peaks with a value equal to or greater than a threshold value among the respective measured peaks on the chromatogram of the measured standard sample match the first retention times Q1ⱼ within the first tolerance widths Z1ᵢ (j is a natural number of 1 or more) in the standard sample timetable 31. The tolerance range is the first retention time Q1ⱼ and the corresponding first tolerance width Z1ⱼ.

Next, it is determined whether all the remaining peaks have been identified (step S40).

When the answer is “Yes” in step S40, the measurement sample timetable setting unit 24 sets the original VIS2 standard sample timetable 31 as the VIS2 measurement sample timetable 33 without changing the original VIS2 standard sample timetable (step S42).

When the answer is “No” in step S40, the peak extraction unit 21 determines a measurement window using, for example, the original VIS2 standard sample timetable 31, as in step S6 of FIG. 4 (step S44). The measurement window may be the measurement window that is set using the original VIS1 standard sample timetable 31 in step S6 of FIG. 4.

Next, as in step S8 of FIG. 4, the number f of measured peaks having an intensity and/or peak area that is equal to or higher than a predetermined threshold value for VIS2 within the measurement window is counted (step S46). In this case, the predetermined threshold value for VIS2 can be set in the same way as in step S8 of FIG. 4 and, specifically, set such that the peaks of the identification target components (peaks of Pro, Hypro, etc.) can be detected in the VIS2 chromatogram.

Next, as in step S10 of FIG. 4, the peak extraction unit 21 determines whether the number f of measured peaks matches the specified number g of peaks (g=1 in this example) that is to be identified and quantified at the wavelength VIS2 from the standard sample (step S48).

When the answer is “No” in step S48, the standard sample timetable modification unit 22 does not modify the original VIS2 standard sample timetable 31 but outputs an error and ends the processing. This is because when the measurement results in “No” in step S48, like step S10 of FIG. 4, there is a likelihood that the measurement is inaccurate because the shift of the retention time of the peak exceeds a level that cannot be compensated for.

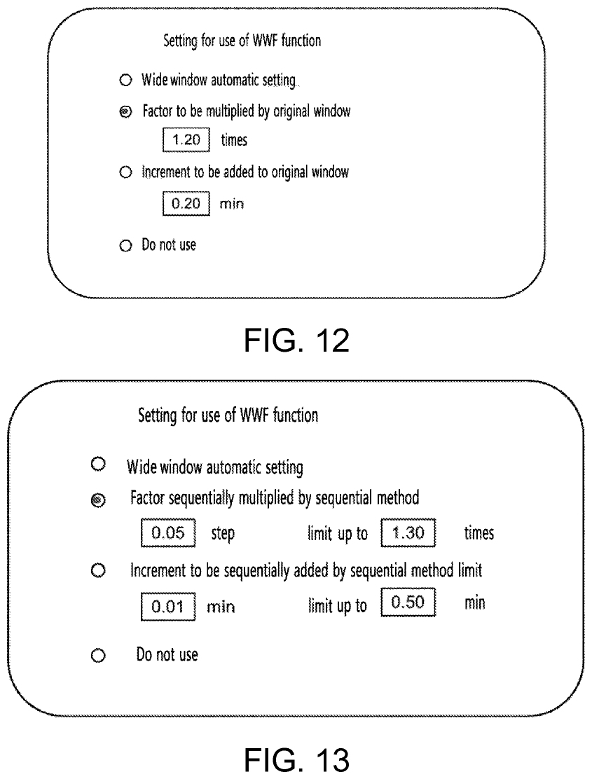

When the answer is “Yes” in step S48, like step S12 of FIG. 4, the standard sample timetable modification unit 22 changes the first tolerance width Z1ⱼ of the original VIS2 standard sample timetable 31 to a changed tolerance width Z2ⱼ that is wider than the first tolerance width (step S50, FIG. 10).

Following step S50, the standard sample identification unit 23 determines whether all the measured peaks (g peaks) have been identified from the modified VIS2 standard sample timetable 31 (step S52). The identification is a process of determining whether or not the measured peaks match the respective first retention times Q1ⱼ within respective tolerance ranges including the respective changed tolerance widths Z2ⱼ in the modified standard sample timetable 31. The tolerance range is the first retention time Q1ⱼ and the corresponding changed tolerance width 10 Z2ⱼ.

When the answer is “No” in step S52, the measurement sample timetable setting unit 24 neither perform the subsequent processing steps nor modify the original VIS2 standard sample 5 timetable, but outputs an error and ends the processing. This is because like the case of step S48, when the measurement results in “No” in step S52, there is a likelihood that the measurement is inaccurate because the shift of the retention time of the peak exceeds a level that cannot be compensated for.

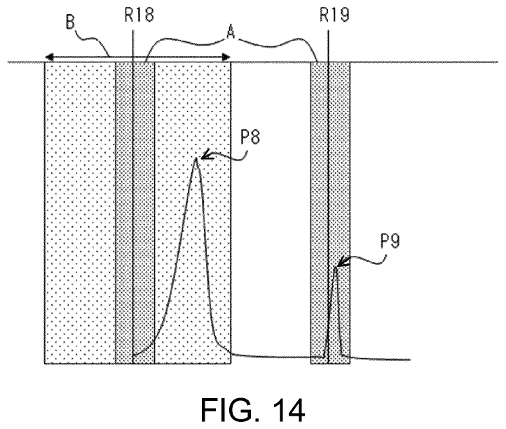

On the other hand, when the answer is “Yes” in step S52, the measurement sample timetable setting unit 24 obtains the retention time of the measured peak as the measured retention time Q3ⱼ. Then, the VIS2 standard sample timetable is updated, for example, as shown in FIG. 11, using the measured retention time Q3ⱼ and a predetermined second tolerance width Z3ⱼ. Then, the updated VIS2 standard sample timetable is set as the VIS2 measurement sample timetable 33 (step S54).

In this example, the second tolerance width Z3ᵢ is set to the original first tolerance width Z1ⱼ, i.e., the second tolerance width Z3ᵢ is narrower than the changed tolerance width Z2ⱼ. By changing the second tolerance width Z3ⱼ to be narrower than the changed tolerance width Z2ⱼ, errors in peak identification during analysis of a measurement sample can be suppressed, and analysis accuracy is improved.

However, the method of setting the second tolerance width Z3ⱼ is not limited to this method.

After preforming step S42 or S54, the process proceeds to step S20 in FIG. 4, and the measurement sample is analyzed. Specifically, the measurement sample identification unit 25 uses the VIS1 and VIS2 measurement sample timetables 33 to identify the peaks of the measurement sample and calculate the peak areas for quantification (step S20). Then, if necessary, the measurement is completed through an optional step S22 described later.

### [Modification of Setting Method of Changed Tolerance Width]

The method of setting the changed tolerance widths W2ᵢ and Z2ᵢ is not limited. For example, each of the changed tolerance widths W2ᵢ may be set by multiplying each of the first tolerance widths W1ᵢ set in the original standard sample timetable by a specified factor, or adding the specified factor to each of the first tolerance widths W1ᵢ.

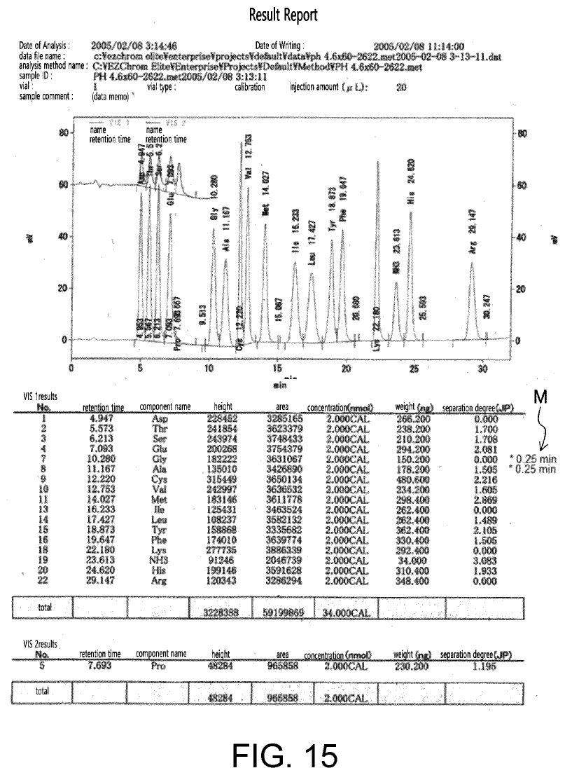

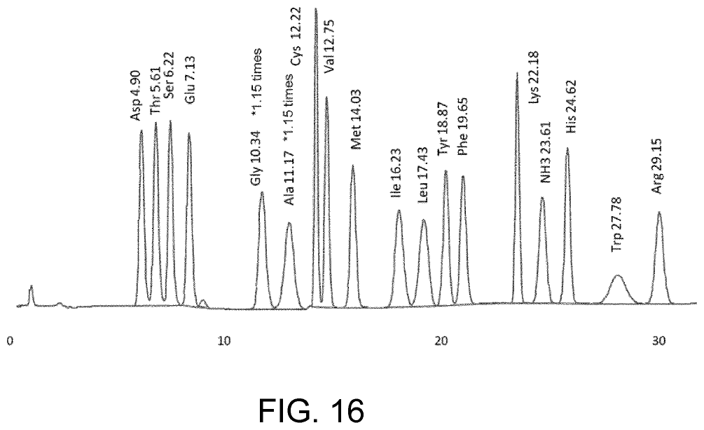

Specifically, for example, as shown in FIG. 12, an input screen of the display unit 51 may be provided with an input box that indicates a magnification factor by which the first tolerance width W1 is to be multiplied, to set the changed tolerance width W2ᵢ or Z2ᵢ, and the user may enter a numerical value as the magnification factor. In addition, as shown in FIG. 13, the input screen of the display unit 51 may be provided with an input box that indicates a value of an increment from the first tolerance width W1ᵢ, Z1ᵢ (0.05 step in FIG. 13, that is, 0.05 min) to set the changed tolerance width W2ᵢ, Z2ᵢ, and the user may input the value in the input box. In this case, the value of the increment input to the input box is increased stepwise by 0.01 min so that the changed tolerance width W2ᵢ, Z2ᵢ is broadened little by little, and when all the peaks of the standard sample are identified, the increasing is stopped, and the last value is determined as the changed tolerance width W2ᵢ, Z2ᵢ. In the case of FIG. 13, it is also possible to set an upper limit at which the increasing of the changed tolerance width W2ᵢ, Z2ᵢ is stopped to 1.3 times the first tolerance width W1ᵢ, Z1ᵢ.

### [Addition of Mark Information]

It is preferable that the output instruction unit 26 attaches mark information (mark) to the identified measured peaks corresponding to the peaks outside the first tolerance width W1 and outputs the measured peaks with the mark information (step S22 in FIG. 4).

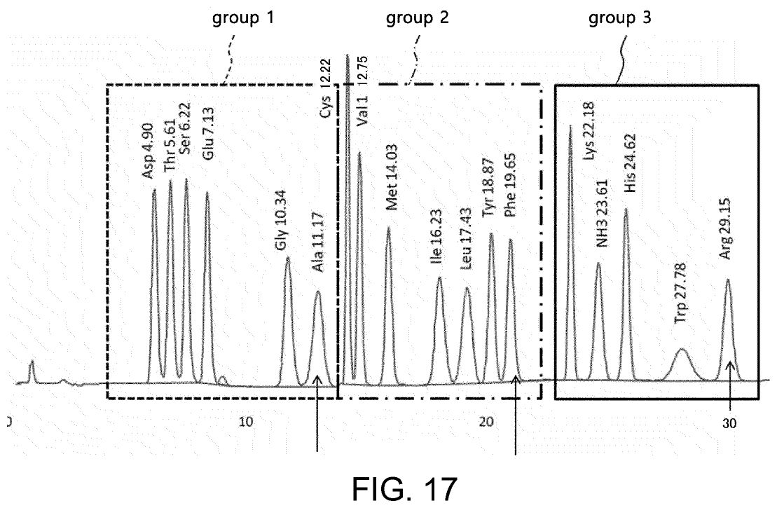

Specifically, the processing of step S22 in FIG. 4 can be performed as shown in FIG. 14, for example. First, in step S14, the standard sample identification unit 23 identifies all the measured peaks (m measured peaks) in the modified standard sample timetable 31, and also identifies all the measured peaks (m measured peaks) in the original standard sample timetable 31. In this case, it can be seen that, for example, the peak P8 of the eighth component is outside the tolerance range (window) A of the original standard sample timetable 31, while the peak P9 of the ninth component is within the tolerance range A.

Therefore, the output instruction unit 26 attaches identification information (for example, flag) to the data of the peak P8 that is outside the tolerance range A, and outputs the identification results of the measured peak to the display unit 51 as appropriate, so that the measured peak is displayed along with the mark indicating the effect. In addition, in FIG. 14, the peak P8 is within the tolerance range (window) B of the modified standard sample timetable 31.

FIG. 15 shows one embodiment of displaying marks attached to measured peaks of a standard sample, which are identified as peaks outside the first tolerance width W1.

FIG. 15 is an example of a result report displayed by the display unit 51. In FIG. 15, aside from the chart (upper part) of the measured peaks, the identification results (peak number, retention time, component name, etc.) of the measured peaks of each measurement sample are displayed in a table format (lower part), and marks M are shown on the right side of the seventh and eighth component columns (peak numbers 7 and 8). This mark M is represented as an asterisk * and a numerical value indicating how far the measured retention times of the seventh and eighth components deviate from the tolerance range A.

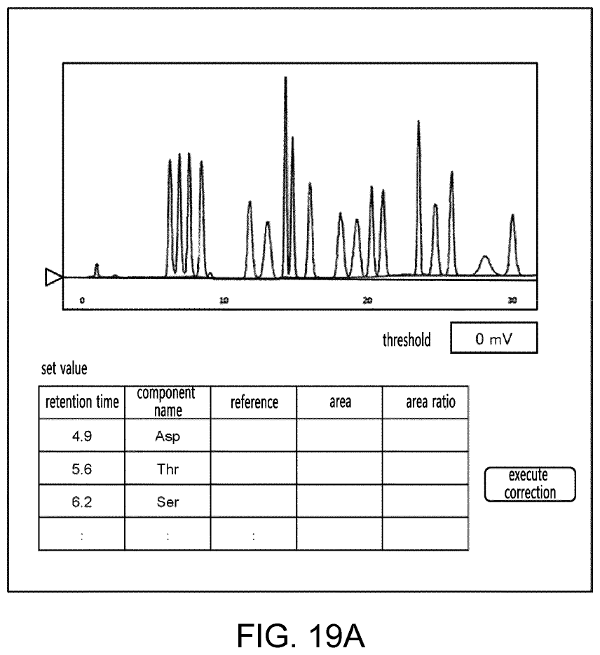

The display format of the mark M is not limited to the above. Alternatively, for example, as shown in FIG. 16, the mark M can also be displayed above the measured peak of the chromatogram.

Numerical values indicating how much each measured retention time of a peak deviates from the first tolerance width W1 include values related to the process when changing from the first tolerance width W1 to the changed tolerance width W2. For example, FIGS. 15 and 16 show, as an example of such a numerical value, the increment (for example, 0.25 min) or magnification factor (for example, 1.15 times) of the change from the first tolerance width W1ᵢ to the changed tolerance width W2ᵢ.

For example, a magnification factor of 1.15 times means that when the first tolerance width W1 is ±0.20 minutes, the time window is gradually expanded, and a certain peak is captured for the first time in a changed tolerance width W2 of ±0.23 minutes. When the first tolerance width W1 is ±0.30 minutes, it means that the tolerance width is gradually increased, and a certain peak is captured for the first time in a changed tolerance width W2 of ±0.55 minutes.

As described above, by outputting the identified measured peaks that are outside the first tolerance width W1ᵢ, Z1ᵢ while attaching the mark information (mark M) to the identified measured peaks, it is possible to help the user recognize that the peaks of the standard sample are measured based on the peak of the standard sample measured in step S14, S52 using the modified standard sample timetable 31. This gives the user information to infer, for example, the cause of the shift in peak retention time. This contributes to analysis of the cause of the shift in peak retention time or to improvement in the shift of the peak retention time.

The mark information is not limited to the mark M, but it may be anything that can be recognized by the user.

### [Verification of Peak Identification Results]

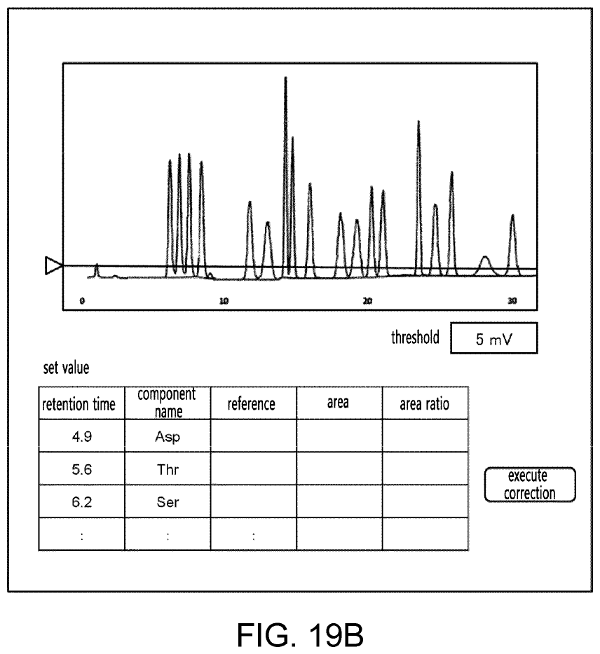

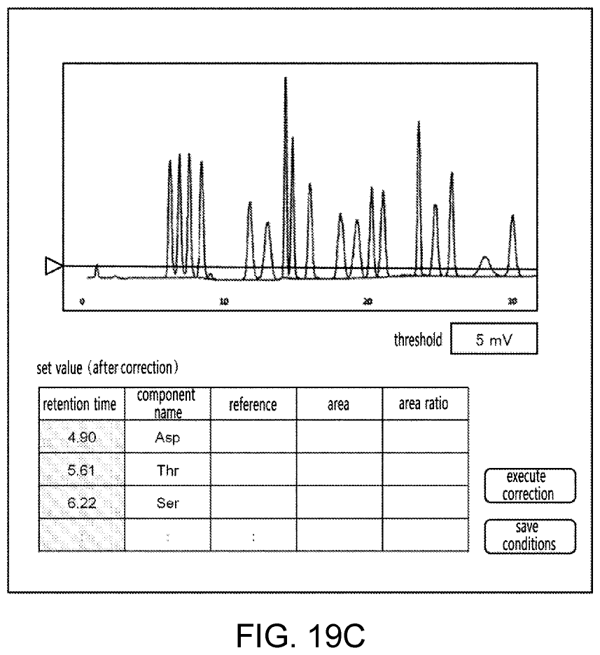

Further, as denoted by reference numeral C in FIG. 4 and as shown in FIG. 17 and FIG. 18, before performing step S20, step S19 may be performed to verify that the peaks of the standard sample identified in steps S2 to S16 and S18 are correct.

For example, as shown in FIG. 17, amino acids measured at the wavelength VIS1 are divided into three groups depending on the properties of each compound.

In this case, it is determined whether the peak of the last eluted component (the component with the longest retention time) of each group is within the second tolerance width W3.

For example, in FIG. 17, it is determined whether the sixth peak of the last eluted component (Ala: alanine) of Group 1 is detected within a range of the measured retention time T6 and the corresponding second tolerance width W36, whether the thirteenth peak of the last eluted component (Phe: phenylalanine) of Group 2 is detected within a range of the measured retention time T13 and the corresponding second tolerance width W313, and whether the peak of the last eluted component (Arg: arginine) of Group 3 is detected within a range of the measured retention time T18 and the corresponding second tolerance width W318. The three groups of amino acids are groups that are eluted while switching among multiple eluents (buffers, or mobile phases).

The reason for determining the peak of the last eluted component is because the later the eluted component is, the greater the shift in retention time due to fluctuations in measurement conditions.

In FIG. 17, when the peak of the last eluted component in each group is within the second tolerance width W3, the determination of FIG. 18 is further performed. When the peak is detected outside the second tolerance width W3, it is determined that correct identification cannot be made.

Next, as shown in FIG. 17, the correlation coefficient rₖ between the measured retention time Tᵢ and the first retention time Rᵢ for very eluted component i belonging to each group k is calculated according to Expression 1 shown below.

Then, when all the correlation coefficients r₁ to r₃ of each group are equal to or higher than a standard value (for example, 0.9 or more), the identified peaks are considered correct. When even one of the three groups does not satisfy the reference value, the identification is determined not to be correct.

$${r}_{k} = \frac{{\sum }_{i} ( {t}_{i} - \overline{t} ) ( {R}_{i} - \overline{R} )}{\sqrt{{\sum }_{i} {( {t}_{i} - \overline{t} )}^{2} {\sum }_{i} {( {R}_{i} - \overline{R} )}^{2}}} \qquad [ Expression 1 ]$$

In addition, when there is only one group, the determination shown in FIG. 17 is performed on the peak of the last eluted component of that group, and the determination shown in FIG. 18 is further performed on all the measured components of that group.

As a method of determining the accuracy of the peaks of the standard sample identified in steps S2 to S16, for example, the peak widths may be determined.

The peak width “s” in a chromatogram is indicated only in units of time, and unlike the peak area and peak height (signal intensity), the peak width does not change in proportion to the concentration or injection amount of each component to be measured, and is almost unique to each component to be measured. For example, the peak width “s” is a value obtained by dividing the peak area “μV·s” by the peak height “μV”, or the full width at half maximum “s” can also be used as the peak width.

Therefore, the upper and lower limits of the peak width are set as thresholds for each component in advance, and when the peak width of each identified component is within the threshold, it can be determined that that component has been correctly identified as a peak.

### <Features and Effects>

In the chromatographic data processing device and data processing method, when the retention time of a peak is shifted due to fluctuations in measurement conditions, the tolerance width W1ᵢ (and Z1ᵢ if necessary) is widened to mitigate the identification conditions of the standard sample, thereby preventing an event that the standard sample cannot be identified. In addition, since the first tolerance widths W1ᵢ, Z1ᵢ are widened only when the number of measured peaks matches the specified number of peaks, it is possible to prevent an event in which the standard sample though the measurement results become is identified even inaccurate, i.e., the both numbers are not identical, and the shift of the retention is at a level that cannot be compensated for.

When the standard sample has been identified, the standard sample timetable is updated using the measured retention times of the measured peaks, and the updated standard sample timetable is set as the measurement sample timetable. Therefore, even when the retention times of peaks vary due to fluctuations in measurement conditions, the measurement sample can be identified with high accuracy.

In particular, in the present disclosure, in steps S8 and S46, the predetermined threshold values may be variable values that can be set by the user.

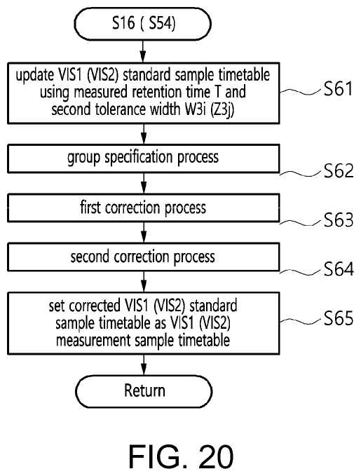

Specifically, an example of a procedure in which the user sets a predetermined threshold value in steps S8 and S46 will be described with reference to FIGS. 19A to 19C.

FIGS. 19A to 19C illustrate an example of an operation screen of the chromatogram data processing device 50 according to the present disclosure.

Specifically, the figures show a VIS1 chromatogram and a VIS1 standard sample timetable.

FIG. 19A shows a screen before the user adjusts the predetermined threshold value, and the threshold value is displayed as 0 mV.

In this example, as shown in FIG. 19B, the user can adjust the threshold value by adjusting the position of a threshold value cursor displayed on the chromatogram (in FIG. 19B, the threshold value is displayed as 5 mV). The threshold value cursor is a horizontal cursor that is displayed on the chromatogram and which can extend in a horizontal axis direction. The threshold value cursor can be configured to be movable in a vertical axis direction by, for example, a user's click and drag operation. In addition, by the user's drop operation of the threshold value cursor, information on the position of the threshold value cursor in the vertical axis direction is acquired as the threshold value selected by the user, and it is displayed in the threshold value box. The method in which the user adjusts the threshold value is not limited to the method described above. Alternatively, for example, the user may be able to directly enter a numerical value as the threshold value into the threshold value box.

As shown in FIG. 19C, when the position of the horizontal cursor is fixed at a threshold value of 5 mV, and the “Execute correction” button is clicked, the threshold value is set to 5 mV, and the processes of steps S8 to S16 described above are executed. Then, as shown in the cells with dotted hatching in FIG. 19C, the information on the retention times in the standard sample timetable is corrected with the information on the measured retention times T of the measured peaks with an intensity equal to or higher than the threshold value of 5 mV. In this example, the peaks are identified starting from the component with the shorter retention time.

In this way, when the predetermined threshold value is a variable value that can be set by the user, peak identification intended by the user can be more practically and flexibly implemented.

### Embodiment 2

Another embodiment of the present disclosure will be described in detail below. Through the description of each of the embodiments, the same constituent elements as those in the first embodiment are denoted by the same reference numerals, and a redundant description will not be given.

### <Peak Position Correction Function>

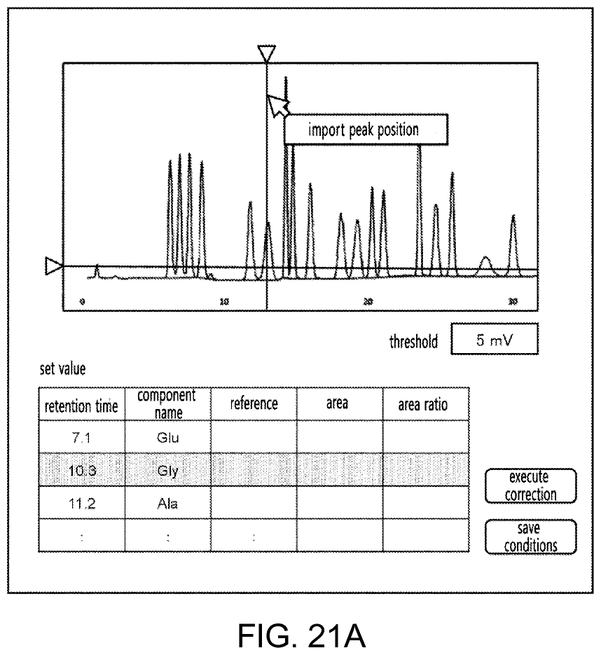

For example, when dealing with an amino acid sample with a large number of components to be identified, depending on separation conditions, extra peaks, such as the Pro and Hypro peaks mentioned above, which are difficult to eliminate simply by adjusting the threshold value, may exist, and in this case, the accuracy of peak identification may decrease. As a countermeasure for such a case, a function in which the user can manually correct the peak position may be provided. That is, as an example of the peak position correction function, for example, as shown in FIG. 20, before proceeding to step S20 from step S16 of FIG. 4 or step S54 of FIG. 5, a standard sample timetable correction step for correcting the second retention time of the updated standard sample timetable may be included.

As shown in FIG. 20, the standard sample timetable correction process is a process provided after step S61 of updating the standard sample timetable in the process of step S16 or step S54, and the standard sample timetable correction process includes a pair designation process S62, a first correction process S63, and a second correction process S64. Then, as part of the processing in step S16 or step S54, the standard sample timetable corrected in the standard sample timetable correction process is set as a measurement sample timetable (step S65).

The pair designation process S62 is a process of designating a pair of a predetermined component in the standard sample timetable and a predetermined peak in the peak group.

The first correction process S63 is a process of correcting the second retention time of the predetermined component using the measured retention time of the predetermined peak.

The second correction process S64 is a process of correcting the second retention time of a component that is eluted before or after the predetermined component (i.e., shorter retention time or longer retention time than the retention time of the predetermined component) on the basis of a difference between the second retention time before the first correction process and the second retention time after the first correction process of the predetermined component.

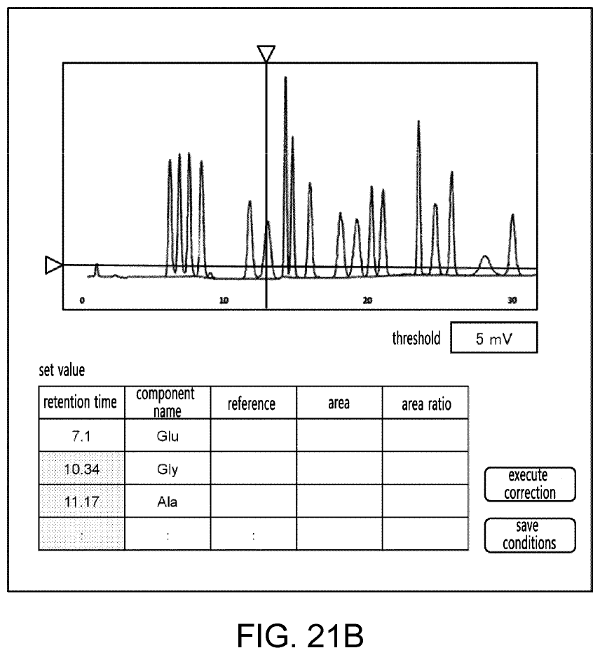

Specifically, FIGS. 21A and 21B are diagrams illustrating an example of the standard sample timetable correction process.

For example, the case of correcting the peak position of glycine (Gly, predetermined component) displayed on the standard sample timetable, that is, the retention time of Gly, is considered. First, as shown in FIG. 21A, in the standard sample timetable, the row of Gly, which is the component having the peak position (retention time) to be corrected (in FIG. 21A, shaded with dots), is clicked and selected. Then, the user selects a peak (predetermined peak) that is determined to correspond to Gly (pair designation step S62), using the peak position cursor. The peak position cursor is a vertical cursor that is displayed on the chromatogram and which extends in a vertical axis direction. The peak position cursor is configured to be movable in the horizontal axis direction by, for example, a user's click and drag operation. By the user's drop operation of the peak position cursor, the position of the peak position cursor in the horizontal axis direction can be determined. In the state in which the position of the peak position cursor in the horizontal axis direction is determined, for example, when the user perform a right click operation on the peak position cursor, the command “import peak position” appears.

Next, when the above-mentioned command “import peak position” is selected, as shown in the cell shaded with dots in FIG. 21B, the information on the horizontal axis position on the peak position cursor is obtained as the peak position selected by the user (as the retention time of the peak selected by the peak position cursor), and displayed in the cell of the retention time of Gly of the standard sample timetable (first correction process S63). In other words, by the above-described operation, the retention time of Gly is corrected to the information of the retention time of the peak selected by the user.

In this example, the peak positions are identified in ascending order of retention time. In this case, by executing the command, in addition to correcting the retention time of Gly, the retention times of other components with longer retention times than Gly are also corrected on the basis of the retention time of the peak selected using the peak position cursor (second correction process S64).

By implementing such a peak position correction function, even though there are extra peaks that are difficult to eliminate by simply adjusting the threshold value, the peak position can be corrected at the user's decision, and the accuracy of peak identification can be improved. In this way, the peak identification intended by the user can be realized more practically and flexibly.

The peak position correction function performed by the user is not limited to the function described above. Specifically, for example, by executing the above-described command, not only the retention time of the component to be corrected, the retention times of other components whose retention times are shorter than the component to be corrected may be corrected. This configuration is particularly effective when identifying peak positions in descending order of retention time. Furthermore, based on the retention time of the component of the selected peak, the retention times of both components with longer and shorter retention times than the component may be corrected. Furthermore, a plurality of peak position cursors may be provided in case there are a plurality of extra peaks that are difficult to eliminate simply by adjusting the threshold value.

In this example, the peak position correction function is incorporated as part of step S16 (S54). For example, the peak position correction function may be performed, for example, before updating the standard sample timetable. Specifically, for example, as indicated by reference numeral B in FIGS. 4 and 5, when the answer in step S10 (S48) is “No”, the processing flow may return to step S8 (S46) after the peak position correction (step S9 (S47)).

In this case, the pair designation process S62 is a process of specifying a pair of a predetermined component in the standard sample timetable and a predetermined peak in the peak group.

The first correction process S63 is a process of correcting the first retention time of the predetermined component by the measured retention time of the predetermined peak.

The second correction process S64 is a process of correcting the first retention time of components that are eluted at least one of before and after the predetermined component (i.e., component with a shorter retention time and component with a longer retention time than the retention time of the predetermined component) on the basis of a difference between the first retention time determined before the first correction process for the predetermined component and the first retention time determined after the first correction process for the predetermined component.

### Embodiment 3

As shown in FIG. 4, a contaminant peak determination process (step S15 denoted by reference numeral D) for verifying the result of the peak identification process (step S12 and step S14) is provided between step S4 and step S18 and/or between step S14 and step S16.

In the contaminant peak determination process, for each of the target peaks identified through the peak identification process, the area ratio is calculated using the peak area of one component as the reference, and when there is a peak whose actual area ratio differs from the area ratio information stored in the standard sample timetable by more than a predetermined area ratio tolerance, the peak is determined as a contaminant peak. The contaminant peak determination process is implemented in a program as, for example, an area ratio reference function.

### <Area Ratio Reference Function>

The standard sample timetable may further include information of the peak area of each of the target peaks and information of the area ratio of the peak area of each of the target peaks with respect to the peak area of one arbitrary component among the target peaks.

In this case, it can be assumed that the area ratio for the case where the same standard sample as the standard sample used to create the original standard sample timetable is measured is approximately the same as the area ratio included in the standard sample timetable.

That is, whether the identification result of the target peak is correct is verified by comparing the area ratio of the target peak identified through the peak identification process with the area ratio included in the standard sample timetable.

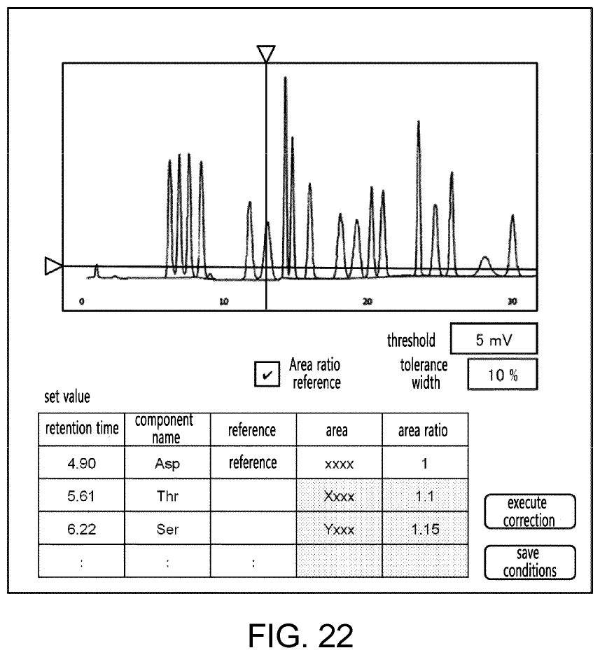

Specifically, for example, as shown in FIG. 22, the standard sample timetable contains information such as component names, retention times, and peak areas. In this standard sample timetable, the cell in the reference column and the Asp row is clicked so that the peak of Asp is set as the reference. (in FIG. 22, the message “reference” is displayed in the cell). Then, when the peak area of Asp is set to 1, the area ratio of each of the peak areas of the other components is calculated and displayed in the area ratio column. Then, it is determined whether the area ratio is within the value range set as the tolerance width (the tolerance width is set to 10% in the example of FIG. 22). When the area ratio falls within the range of the tolerance width, the identification result of the target peak is determined to be correct. On the other hand, when the area ratio does not fall within the range of the tolerance width, the identification result of the target peak is determined to be incorrect. In this case, for example, an error will be output. Alternatively, a configuration may be adopted in which the peak determined to be incorrect is excluded from the identification targets and is determined to be a contaminant peak that is not the peak of the component to be identified.

With this configuration, it is possible to easily verify peak identification results and correct retention times when there are confusing contaminant peaks, when the separation column is replaced, and when multiple devices are operated, and it is possible to improve identification accuracy.

The tolerance width of the area ratio is not particularly limited, but may be, for example, 5% or more and 15% or less. When the tolerance width of the area ratio is less than 5%, the tolerance width is excessively narrow, and thus there is a high possibility that correct peaks will be determined to be incorrect peaks. This may reduce the accuracy of peak identification. When the tolerance width of the area ratio exceeds 15%, the tolerance width is excessively broad, and thus incorrect peaks may not be accurately discriminated, and the accuracy of peak identification may deteriorate.

### Embodiment 4

### <Threshold Value Adjustment-Type Peak Extraction Function>

In the peak extraction process (steps S8 and S10 in FIG. 4) of Example 1 described above, the user is allowed to input the lower limit threshold value of the detection signal for counting the number of peaks, and the control unit determines whether the count number is appropriate.

The peak extraction process is not limited to the configuration of Embodiment 1. Instead of the configuration of Embodiment 1, for example, a processing flow of a threshold value adjustment-type peak extraction function may be adopted. In this processing flow, the threshold value is an automatically configurable variable value to extract the target peaks. Specifically, for example, first, the lower limit threshold value is raised once, and then gradually lowered, and the number of peaks is counted as 1, 2, 3, . . . .

Then, for example, when a predetermined number (i.e., 18) is reached, the decreasing the threshold value is stopped. Therefore, component names are assigned to the target peaks in order of retention time, and a certain standard is used to determine whether this peak identification result is appropriate.

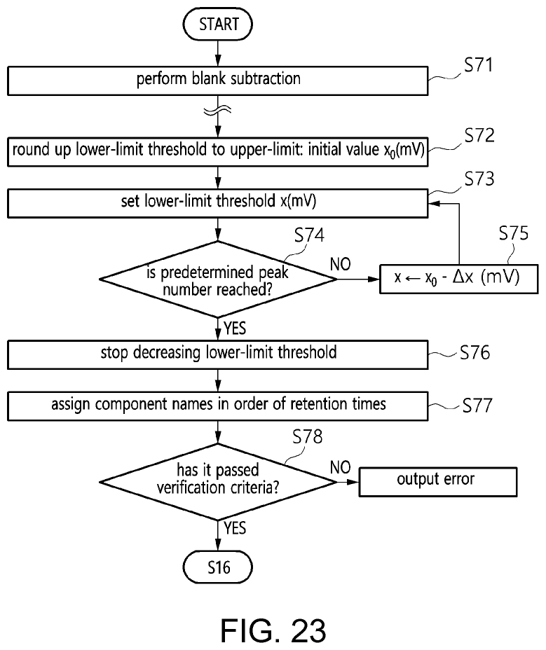

FIG. 23 illustrates an example of a processing flow of a threshold value adjustment-type peak extraction function.

A blank subtraction process (step S71), which is an optional process, is a kind of pretreatment process in which the detection baseline of a blank sample is subtracted from the chromatogram of the standard sample in order to substantially level the baseline. When the blank subtraction processing is not performed, the raised baseline portion may be mistakenly recognized as a peak, so it is desirable to perform the blank subtraction processing.

When the blank subtraction of step S71 is included, this process is performed before step S2 in FIG. 4. The following steps S72 to S76 can then be provided in place of steps S8 and S10 in FIG. 4. Steps S77 and S78 can be provided in place of steps 12 and S14 in FIG. 4. That is, steps S2 to S6 in FIG. 4 (omitted in FIG. 23) are performed between step S71 and step S72 in FIG. 23.

For example, the lower limit threshold value x is once raised to the initial value x₀ (for example, 1,000 mV) (step S72). The lower limit threshold value x is reduced by Δx (for example, 10 mV) (step S75), and the number of peaks is counted (steps S73 and S74).

When the predetermined number (for example, 18) is reached, the decreasing the threshold value is stopped (step S76).

Provisional peak identification is performed by assigning component names in the order of the first retention time (step S77).

It is checked whether the identification result is appropriate (step S78). For example, the test criterion is that the peak width equivalent time obtained by dividing the peak area of each peak by the peak height is within the range of 10 seconds to 60 seconds. Several other verification criteria can be considered. For example, the area ratio reference function as in Embodiment 2 may be used. When a detected peak cannot pass the test criteria, the processing may be terminated by, for example, outputting an error.

By employing the threshold value adjustment-type peak extraction function, peak identification for the accurate number of peaks can be performed more effectively.

### Embodiment 5

### <Threshold Value Adjustment-Type Peak Extraction Function: Maximum Value Search Method>

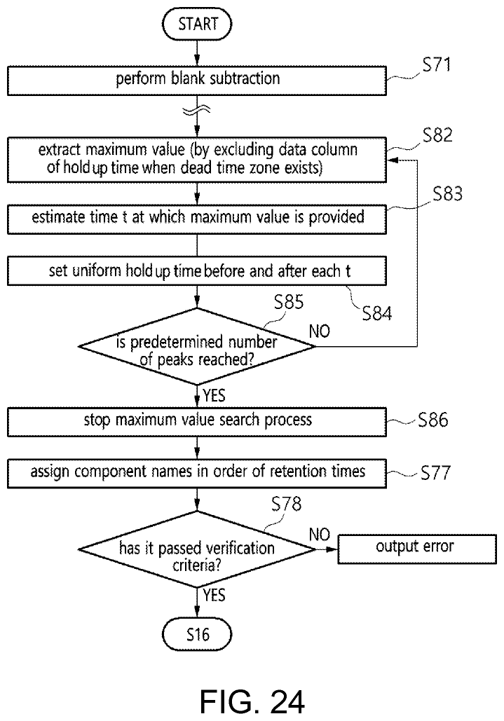

A maximum value search method may be used as a method equivalent to the threshold value adjustment-type peak extraction function of Embodiment 4, which is a processing flow including a modification of the peak extraction process. In the maximum value search method, the maximum value is found one after another, and while providing a holdup time at each relevant time, the search for the maximum value is continued until a predetermined number of peaks are detected. FIG. 24 illustrates an example of a processing flow of the maximum value search method. As shown in FIG. 24, in this example, the following steps S82 to S86 are executed in place of steps S72 to S76 of Embodiment 4 shown in FIG. 23. Therefore, the same processes (steps S71, S77, and S78) as in Embodiment 4 are denoted by the same reference numerals, and a redundant description thereof will be omitted.

Specifically, for example, in step S82, which is a maximum value extraction process, the maximum value of the signal intensity in the data string of the chromatogram is extracted.

Then, in step S83, which is a recognition process, the peak that gives the extracted maximum value is recognized as one of the target peaks, and the time t that gives the maximum value is found.

Next, in step S84, which is a dead time zone setting process, a holdup time of a predetermined time period including the time t giving the above-mentioned maximum value is set. The holdup time period is not particularly limited, but can be set to, for example, ±0.1 minutes to ±0.5 minutes.

Then, in step S85, it is determined whether the number of extracted target peaks has reached a predetermined number of peaks.

When the answer is “no” in step S85, the maximum value extraction process, the recognition process, and the holdup time setting process are repeated for the data string of the chromatogram from which the data string in the holdup time is extracted, and the remaining target peaks are extracted (iterative process). Then, the maximum value extraction process, the recognition process, and the holdup time setting process are repeated until the number of extracted target peaks reaches a predetermined number of peaks.

When the answer is “yes” in step S85, that is, when the number of extracted target peaks reaches a predetermined number of peaks, the maximum value search process is stopped (step S86). Then, the process proceeds to step S77 and subsequent steps.

### Embodiment 6

### <Special Case of Hydro Xylidine (Hylys)>

For example, as shown in FIG. 25, the peak of Hylys, which is a type of amino acid, may have two tips like a spoke. This is because two types of diastereomers exist. The peak identification for the Hylys peak is difficult because the tips of the peak are separated or are not separated, depending on separation conditions or other factors.

Since the peak extraction method based on the maximum value search of Embodiment 5 described above provides a holdup time, even though the tip is split, the spoke peak is counted as one peak, so there is no problem.

Since the threshold value adjustment-type peak extraction function of Example 4 counts one peak as two peaks when the tip of one peak is split, it is a good idea to set a holdup time in which the peak is not recognized, like the maximum value search method. Alternatively, when it is found that two Hylys peaks are counted in the test when the predetermined number is reached, a method in which the lower limit threshold value is reduced again and one more peak is counted will be adopted. Furthermore, when the tip of the Hylys peak is divided into two, a function of grouping these peaks as the peak of one component may be adopted.

### Embodiment 7

### <Count-Up Extraction Method>

As a modification to the peak extraction process, a count-up extraction method may be used. The count-up extraction method can be provided in place of steps S8 and S10 in FIG. 4.

In the first place, before assigning component names of peaks, it is necessary to extract a number of peaks corresponding to the number of components set in the standard sample timetable. When the number of components and the number of peaks match, it is sufficient that component names are assigned in ascending order of retention time length. When the standard sample has been successfully analyzed, ideally, the number of components and the number of peaks will match.

The count-up extraction method as the peak extraction process includes a peak detection process of detecting a peak group. In the method, a number of target peaks corresponding to the number of target components will be extracted from the peak group detected through the peak detection process, in descending order of peak size.

In the peak detection process, peaks are detected using detection parameters such as noise and slope. When the detection parameters are excessively sensitive, in some cases, a slightly larger number of peaks than the intended number of components can be detected, but these peaks have significantly lower heights than peaks originating in the components contained in the standard sample. Low peaks may be contaminant components contained in the standard sample or may be baseline noise. Therefore, by extracting a number of peaks corresponding to the number of components in descending order of peak height, it is possible to secure a necessary and sufficient number of peaks and to assign component names to the respective detected peaks. This process can be called count-up extraction (CUE) because the peaks are extracted and counted up to the number of peaks required for assignment. This counting process is equivalent to the process of varying and adjusting the threshold value. This is because both the counting process and the threshold value adjustment process are based on the number of components, and the role of the component number is to stop the process.

For example, the essence of the peak identification method in Embodiment 1 is that although the peak extraction process utilizes the detection intensity characteristic on the vertical axis of the chromatogram, represented by the peak height, the component name assignment process is based solely on the retention time, which is the horizontal axis information, regardless of the order of heights.

On the other hand, the CUE method is characterized in that it only extracts the required number of components based on peak heights, and the peak height information has no effect on component name assignment.

Here, the time interval of the chromatogram targeted by the CUE method may be from the beginning to the end of data collection, or may be a relatively wide window.

That is, in the CUE method, since the above-mentioned peak detection process is included, the threshold value adjustment method is replaced by a method of counting the number of peaks. Additionally, it can be considered that the number of detected peaks is smaller than the number of components, but this may mean that the standard sample could not be analyzed correctly, and it is regarded as an error.

An advantage of the CUE method is that there is no need to set the initial value of the threshold, which is necessary in the threshold value adjustment-type peak extraction function described above. Since the number of peaks is a direct adjustment index, there is no longer a need to adjust the threshold value to match the number of components. In addition, there is no need to set a holdup time, which is required in the maximum value search method. This is because the peak detection process eliminates the need for special parameters such as holdup time.

By the way, the index that has been referred to as the peak height is the value of the y-coordinate of the vertical axis of the chromatogram, that is, the signal intensity at the apex of the peak. The signal strength is simply the intensity of detection. Typical data processing methods include a baseline setting process. When this is done and the baseline setting is completed, the peak height above the baseline can be used instead of the y-coordinate. Furthermore, instead of peak height, the order of peak area can also be used to count the number of peaks. That is, in the CUE method, both the peak height and the peak area above the baseline can be used after the baseline setting process. That is, the y-coordinate, the peak height after setting the baseline, and the peak area are all peak sizes, and can be used as indexes for selection in order of size. In other words, in this example, “peak size” refers to the signal intensity of the peak, the peak height above the baseline after baseline setting (the difference between the signal intensity at the apex of the peak and the signal intensity at the baseline), or the peak area above the baseline after baseline setting (the area of the portion of the peak above the baseline).

Some special cases can be considered. As mentioned above, Pro is an unnecessary component in the case of VIS1 and appears as a relatively small peak in the VIS1 chromatogram. Since Pro and Hypro are not present in the VIS1 standard sample timetable, the CUE method does not assign component names to VIS1 peaks on the basis of peak size.

Furthermore, for example, in a pre-column derivatization method, a huge peak of the reaction reagent itself may appear. In this case, the component peaks derived from the reaction reagent are placed in the standard sample timetable in advance, and after the component names are assigned by the CUE method, the components derived from the reaction reagent are excluded during the quantitative analysis.

Hylys in Embodiment 6 above is a component included in the standard sample for a PF biofluid analysis method, and the peak may or may not be tip-split. An example of a method of dealing with the special case will be described below. The VIS1 standard sample timetable of the PF method usually contains n components. However, since there are cases where the tip of each peak is split, a timetable including Hylys1 and Hylys2 in a number “n+1” of components is prepared in advance. Then, the CUE method is applied to the chromatograms of the actual standard samples using n and n+1 timetables. Here, it is necessary to determine which timetable is more plausible to use. When a timetable with a number “n” of components is used when a tip-split peak exists, there may be cases where component peaks that need to be extracted cannot be extracted. When component names are assigned in this state, for example, the retention time of the Hylys2 peak will be assigned to another component name. Since the timetable includes the reference time for each component, a large time difference occurs in this situation. When the plausibility is determined on the basis of this large time difference, without bringing up the determination formula represented by Expression 1, it can be determined that n timetables are inappropriate.

Conversely, when n+1 timetables are used in the case where a tip-split peak does not exist, the component name of Hylys2 is assigned to a different peak, resulting in a significant time difference as well. Thus, it can be determined that n+1 timetables are inappropriate, and a timetable including the right number “n” of components can be adopted.

In the plausibility determination method, which sets a tolerance width in advance to determine the significant time difference, the degree of agreement between the intended component peak and the measured peak can be easily confirmed. Therefore, the plausibility determination method is useful to determine whether the CUE method worked correctly for common components.

Another method can be adopted to avoid the special case of Hylys. For example, since the retention time of Hylys is known to some extent in advance, a tip-split peak detection process can be provided at around that time. When two peaks appear at a certain close distance, a tip-split peak flag is set, and the CUE method is executed using the aforementioned VIS1 timetable for a standard sample with n+1 components.

A special assay method regarding the aforementioned Pro peak will be described. First, the CUE method is executed using a standard sample VIS1 timetable that does not contain Pro. Next, the CUE method is executed using a standard sample VIS2 timetable that contains Pro. Since the purpose of the VIS2 CUE method is only to extract a Pro peak, the VIS2 timetable can be used for a small number of components whose chromatogram Pro data collection time ends in the middle of the chromatogram. Here, the Pro peak at VIS1 is also searched for, using the retention time of Pro found in VIS2. To confirm whether the measured Pro peak corresponds to Pro as a component, the ratio is calculated by dividing the Pro peak area obtained at VIS1 (570 nm) by the Pro peak area obtained at VIS2 (440 nm). When this ratio falls within a certain tolerance width, it can be verified that the component is Pro. This is a special peak area ratio assay method applicable to Pro, which is an imino acid. This is an assay method for imino acids, which can handle the Hypro peak of the PF method in the same way. Since imino acids are special, this assay is effective for peak identification verification.

### Other Embodiments

In the embodiments described above, an amino acid analyzer is taken as an example of the chromatographic device 100. However, the chromatographic device is not limited to such a configuration. The chromatographic device 100 may be a variety of liquid chromatographs, gas chromatographs, etc. that analyze other analytical samples.

### Configuration Example

The following are examples of the configuration and effects of the chromatogram data processing method, data processing device, chromatographic device, data processing program, and recording medium that relate to the present disclosure described above.

An example of the configuration of a chromatogram data processing method is a data processing method for processing a chromatogram of a standard sample containing plurality of components, the method comprising:
a peak extraction process that extracts a number of target peaks corresponding to a number of target components to be identified among the plurality of components from a group of peaks appearing on a chromatogram;
a peak identification process that assigns names of the target components to the target peaks, respectively, in descending or ascending order of first retention time, based on a standard sample timetable preloaded with a relationship between the names of the target components and the corresponding first retention times which are the retention times of the target components; and
a standard sample timetable updating process that updates the first retention times in the standard sample timetable, with second retention times that are measured retention times of the target peaks.

According to the present configuration, it is possible to provide a technique for identifying the accurate number of peaks according to changes in a chromatogram, which are attributed to fluctuations in the states of standard samples and measurement samples, measurement conditions, and the like.

In a preferred embodiment,

the peak extraction process is a process of extracting peaks with maximum signal intensity value greater than a threshold value among the group of peaks as the target peaks, and
the threshold value is a user-configurable variable value or an automatically configurable variable value that is capable of extracting the target peaks.

According to the configuration described above, since the threshold value is a variable value that can be set by the user, peak identification intended by the user can be more practically and flexibly implemented. In addition, since the threshold value can be automatically set to a variable value with reference to which the target peaks can be extracted, peak identification for the accurate number of peaks can be performed more effectively.

In another preferred embodiment,

the peak extraction process comprises:
a maximum value extraction process that extracts a maximum value of signal intensity for a data string of the chromatogram;
a recognition process that recognizes a peak that gives the maximum value as one of the target peaks; and
a holdup time setting process of setting a holdup time of a predetermined time length including a time at which the maximum value appears,
in which the maximum value extraction process, the recognition process, and the holdup time setting process are repeated for data strings of the chromatogram excluding a data string of the holdup time to extract remaining target peaks.

According to the present configuration, the accurate number of peaks can be identified more effectively.

In another preferred embodiment,

the peak extraction process comprises a peak detection process that detects the group of peaks and
the peak extraction process extracts the target peaks up to a number corresponding to a number of the target components in descending order according to peak size, from the group of peaks detected through the peak detection process.

According to the present configuration, the accurate number of peaks can be identified more effectively.

In a preferred embodiment,
a standard sample timetable correction process of correcting the updated standard sample timetable is included, and the standard sample timetable correction process includes:
a pair designation process that designates pairs of a predetermined component in the standard sample timetable and a predetermined peak in the group of peaks;
a first correction process that corrects the second retention time of the predetermined component with an measured retention time of the predetermined peak; and
a second correction process that corrects the second retention time of at least one of components that are eluted prior to and subsequent to the predetermined component, based on a difference between the second retention time of the predetermined component before the first correction process and the second retention time of the predetermined component after the first correction process.

According to the present configuration, even though there are extra peaks that are difficult to eliminate only by repeating threshold value adjustment or maximum value extraction, etc., the peak position can be corrected at the user's discretion, and the accuracy of peak identification can be improved. In this way, the peak identification intended by the user can be realized more practically and flexibly.

In a preferred embodiment,

area ratio information of the target peak on a basis of a peak area of one component of the target components is stored in the standard sample timetable and
the method further comprises a contaminant peak determination process that calculates, as an actual area ratio, an area ratio based on a peak area of the one component for each of the target peaks identified in the peak identification process after the peak identification process and before the standard sample timetable updating process and determines a peak as a contaminant peak in case the actual area ratio of the peak differs from an area ratio information that is pre-stored by more than or equal to a predetermined area ratio tolerance width.

According to the present configuration, when there are confusable contaminant peaks, when the separation column is replaced, or when multiple devices are operated, the peak identification results can be easily verified, retention times can be easily corrected, and the accuracy of peak identification is improved.

In a preferred embodiment,

the chromatogram includes a first chromatogram measured on a first channel and a second chromatogram measured on a second channel, the plurality of components include a first target component to be identified from the first chromatogram and a second target component to be identified from the second chromatogram,
the standard sample timetable includes a first channel standard sample timetable corresponding to the first channel and a second channel standard sample timetable corresponding to the second channel, and
after identifying a target peak of the first target component using the first channel standard sample timetable for the first chromatogram, a target peak of the second target component is identified using the second channel standard sample timetable from a group of peaks of the second chromatogram excluding the target peak corresponding to the first target component.

According to the present configuration, the task of selecting a second target component to be identified on the second chromatogram, from the group of peaks appearing on the first chromatogram, and assigning a component name is facilitated.

An example of the configuration of a chromatogram data processing device and a chromatographic device including the data processing device is a data processing device for a chromatogram of a standard sample containing plurality of components, and a chromatographic device equipped with the data processing device, either of the devices including:
a peak extraction unit that extracts a number of target peaks corresponding a number of target components to be identified among the plurality of components from a group of peaks appearing on a chromatogram;
a standard sample timetable in which a relationship between names of the target components and first retention times that are retention times of the corresponding target components is pre-stored;
a peak identification unit that assigns names of the target components to the target peaks in ascending or descending order of the first retention time based on the standard sample timetable; and
a standard sample timetable updating unit that updates the first retention times of the standard sample timetable with second retention times that are measured retention times of the target peaks.

According to the present configuration, it is possible to provide a technique for identifying the accurate number of peaks according to changes in a chromatogram, which are attributed to fluctuations in the states of standard samples and measurement samples, measurement conditions, and the like.

An example of the configuration of a chromatogram data processing program is a data processing program for a chromatogram of a standard sample containing plurality of components, the data processing program causing a computer to execute:
a peak extraction process that extracts a number of target peaks corresponding to a number of target components to be identified among the plurality of components from a group of peaks appearing on a chromatogram;
a peak identification process that assigns names of the target components to the target peaks in descending or ascending order of first retention times, based on a standard sample timetable in which a relationship between names of the target components and the first retention times that are retention times of the corresponding target components, is pre-stored; and
a standard sample timetable updating process that updates the first retention times in the standard sample timetable with second retention times that are measured retention times of the target peaks.

According to the present configuration, it is possible to provide a technique for identifying the accurate number of peaks according to changes in a chromatogram, which are attributed to fluctuations in the states of standard samples and measurement samples, measurement conditions, and the like.

One example of the configuration of a recording medium in which a computer program for processing chromatogram data is stored is a computer-readable recording medium in which a computer program for data processing for a chromatogram of a standard sample containing plurality of components is stored,

The computer program causing a computer to execute:
a peak extraction process that extracts a number of target peaks corresponding to a number of target components to be identified among the plurality of components from a group of peaks appearing on a chromatogram;
a peak identification process that assigns names of the target components to the target peaks in descending or ascending order of first retention times, based on a standard sample timetable in which a relationship between names of the target components and the first retention times that are retention times of the corresponding target components, is pre-stored; and
a standard sample timetable updating process that updates the first retention times in the standard sample timetable with second retention times that are measured retention times of the target peaks.

According to the present configuration, it is possible to provide a technique for identifying the accurate number of peaks according to changes in a chromatogram, which are attributed to fluctuations in the states of standard samples and measurement samples, measurement conditions, and the like.

The technology according to the present disclosure is not limited to the embodiments and configuration examples described above. For example, the embodiments and configuration examples described above are presented to aid easy understanding of the present disclosure, and each of the embodiments and configuration examples should not be construed to necessarily include all of the configurations described. In addition, it is possible to replace a part of the configuration of one embodiment or configuration example with the configuration of another embodiment or other configuration examples, and it is also possible to add the configuration of one embodiment or configuration example to the configuration of another embodiment or configuration example. Moreover, a part of each embodiment or configuration example can be deleted, replaced by another configuration, or added with another configuration.

1. A data processing method for a chromatogram of a standard sample containing plurality of components, the method comprising:
a peak extraction process that extracts a number of target peaks corresponding to a number of target components to be identified among the plurality of components from a group of peaks appearing on a chromatogram;
a peak identification process that assigns names of the target components to the target peaks, respectively, in descending or ascending order of first retention time, based on a standard sample timetable preloaded with a relationship between the names of the target components and the corresponding the first retention times, which are the retention times of the target components; and
a standard sample timetable updating process that updates the first retention times in the standard sample timetable, with second retention times that are measured retention times of the target peaks.

2. The data processing method according to claim 1, wherein the peak extraction process is a process of extracting peaks with maximum signal intensity value greater than a threshold value among the group of peaks as the target peaks and
the threshold value is a user-configurable variable value or an automatically configurable variable value that is capable of extracting the target peaks.

3. The data processing method according to claim 1, wherein the peak extraction process comprises:
a maximum value extraction process that extracts a maximum value of signal intensity for a data string of the chromatogram;
a recognition process that recognizes a peak that gives the maximum value as one of the target peaks; and
a holdup time setting process of setting a holdup time of a predetermined time length including a time at which the maximum value appears,
wherein the maximum value extraction process, the recognition process, and the holdup time setting process are repeated for data strings of the chromatogram excluding a data string of the holdup time to extract remaining target peaks.

4. The data processing method according to claim 1, wherein the peak extraction process comprises a peak detection process that detects the group of peaks, and
the peak extraction process extracts the target peaks up to a number of corresponding to a number of the target components in descending order according to peak size from the group of peaks detected in the peak detection process.

5. The data processing method according to claim 1, further comprising a standard sample timetable correction process that corrects the standard sample timetable that is updated,
wherein the standard sample timetable correction process comprises:
a pair designation process that designates pairs of a predetermined component in the standard sample timetable and a predetermined peak in the group of peaks;
a first correction process that corrects the second retention time of the predetermined component with a measured retention time of the predetermined peak; and
a second correction process that corrects the second retention time of at least one of components that are eluted prior to and subsequent to the predetermined component, based on a difference between the second retention time before the first correction process for the predetermined component and the second retention time after the first correction process for the predetermined component.

6. The data processing method according to claim 3, further comprising a standard sample timetable correction process that corrects the standard sample timetable that is updated,
wherein the standard sample timetable correction process comprises:
a pair designation process that designates pairs of a predetermined component in the standard sample timetable and a predetermined peak in the group of peaks;
a first correction process that corrects the second retention time of the predetermined component with a measured retention time of the predetermined peak, and
a second correction process that corrects the second retention time of at least one of components that are eluted prior to and subsequent to the predetermined component, based on a difference between the second retention time before the first correction process for the predetermined component and the second retention time after the first correction process for the predetermined component.

7. The data processing method according to claim 1, wherein an area ratio information of the target peak on a basis of a peak area of one component of the target components is stored in the standard sample timetable and
the method further comprises a contaminant peak determination process that calculates, as an actual area ratio, an area ratio based on a peak area of the one component for each of the target peaks identified in the peak identification process after the peak identification process and before the standard sample timetable updating process and determines a peak as a contaminant peak in case actual area ratio of the peak differs from an area ratio information that is pre-stored by more than or equal to a predetermined area ratio tolerance width.

8. The chromatogram data processing method according to claim 3, wherein an area ratio information of the target peak on a basis of a peak area of one component among the target components is stored in the standard sample timetable and
the method further comprises a contaminant peak determination process that calculates, as an actual area ratio, an area ratio based on a peak area of the on component for each of the target peaks identified through the peak identification process after the peak identification process and before the standard sample timetable updating process and determines a peak as a contaminant peak in case the actual ratio of the peak differs from an area ratio information that is pre-stored by more than or equal to a predetermined area ratio tolerance width.

9. The data processing method according to claim 1, wherein the chromatogram includes a first chromatogram measured on a first channel and a second chromatogram measured on a second channel,
the plurality of components include a first target component to be identified from the first chromatogram and a second target component to be identified from the second chromatogram,
the standard sample timetable includes a first channel standard sample timetable corresponding to the first channel and a second channel standard sample timetable corresponding to the second channel, and
after identifying a target peak of the first target component using the first channel standard sample timetable for the first chromatogram, a target peak of the second target component is identified using the second channel standard sample timetable from a group of peaks of the second chromatogram excluding the target peak corresponding to the first target component.

10. A data processing device for a chromatogram of a standard sample containing plurality of components, the device comprising:
a peak extraction unit that extracts a number of target peaks corresponding to a number of target components to be identified among the plurality of components from a group of peaks appearing on chromatogram;
a standard sample timetable in which a relationship between names of the target components and first retention times that are retention times of the corresponding target components is pre-stored;
a peak identification unit that assigns names of the target components to the target peaks in ascending or descending order of the first retention time on based on the standard sample timetable; and
a standard sample timetable updating unit that updates the first retention times of the standard sample timetable with second retention times that are measured retention times of the target peaks.

11. A chromatographic device comprising the data processing device according to claim 10.

12. A computer-readable recording medium on which a data processing computer program for a chromatogram of a standard sample containing plurality of components is stored,
the data processing computer program causing a computer to execute:
a peak extraction process that extracts a number of target peaks corresponding to a number of target components to be identified among the plurality of components from a group of peaks appearing on a chromatogram;
a peak identification process that assigns names of the target components to the target peaks in descending or ascending order of first retention times, based on a standard sample timetable in which a relationship between names of the target components and the first retention times that are retention times of the corresponding target components, is pre-stored; and
a standard sample timetable updating process that updates the first retention times in the standard sample timetable with second retention times that are measured retention times of the target peaks.
